(19) United States
(12) Patent Application Publication
(10) Pub. No.: US 2014/0122241 A1
(43) Pub. Date: May 1, 2014

(54) Method and Apparatus for Injecting Advertisements into Mobile Documents

(71) Applicants: Robert Thomas Borucki, Mesa, AZ (US); Richard Varwell Townsend, Edinburgh (GB)

(72) Inventors: Robert Thomas Borucki, Mesa, AZ (US); Richard Varwell Townsend, Edinburgh (GB)

(73) Assignee: NCR CORPORATION, Duluth, GA (US)

(21) Appl. No.: 13/663,711

(22) Filed: Oct. 30, 2012

(51) Int. Cl. G06Q 30/02

(52) U.S. Cl. 705/14.64

(57) ABSTRACT

Techniques for injecting advertisements into mobile documents delivered to mobile devices are presented. Mobile documents are generated that are dynamically sized to the display of the mobile devices and relevant advertisements are also dynamically sized for use in the mobile documents. The mobile documents include an optical code that is encoded with information about a purchase by a customer and allow the customer access to the purchase, for example, an airline boarding pass, event pass or the like.

### FIELD OF THE INVENTION

The present invention relates generally to electronic advertising. More particularly, but not exclusively, it relates to injecting an advertisement into a mobile document displayed on a mobile device.

### BACKGROUND

Any discussion of prior art throughout the specification should in no way be considered as an admission that such prior art is widely known or forms part of common general knowledge in the field.

Mobile devices such as smart phones and tablet computers provide new channels for companies to interact with customers. Companies have found that documents formerly provided to customers only in printed form can be delivered to customers in electronic form on mobile devices. Electronic delivery is usually a lower cost solution for the company and more convenient for the customer. Coupons, tickets, vouchers, receipts, confirmations and boarding passes are examples of the many types of printed documents that can be delivered electronically as mobile documents to mobile devices.

Mobile devices usually have small displays when compared to standard size computer displays and laptop displays. Additionally, different makes and models of mobile devices have different size displays with different resolutions making it difficult to display the same size document on each display. The small displays of the mobile devices also restrict how much information a mobile document can display. Typically, a mobile document includes an optical code, such as a 2D barcode, that is displayed on the mobile device and can be presented for scanning.

Sending a mobile document to a mobile device offers a unique marketing opportunity when an advertisement can be added to the mobile document. There is a perceived value for a company to be able to reach customers with targeted offers, marketing messages and other notifications using mobile documents.

### SUMMARY OF THE INVENTION

Among its several aspects, the present invention seeks to overcome or ameliorate at least one of the disadvantages of the prior art, or to provide a useful alternative.

Among its several aspects, the present invention recognizes there is an advantage to being able to inject relevant advertisements into mobile documents being delivered to a mobile device and that are dynamically sized for the display of the mobile device so as not to interfere with the function of the mobile document.

Among its several aspects, one embodiment of the present invention recognizes that a mobile boarding pass document displayed on a mobile device can be used by a customer in place of a paper boarding pass document to access restricted areas of an airport terminal and to board a flight. The embodiment further recognizes that a relevant advertisement can be injected into the mobile boarding pass document if the advertisement is properly sized to not interfere with other features of the boarding pass. Proper sizing requires dynamically resizing the advertisement based on the size of the target display of the mobile device as well as the size of the other features of the boarding pass, such as the company logo, the optical code and the textual information.

Among its several aspects, another embodiment of the present invention recognizes that a mobile event pass document displayed on a mobile device can be used by a customer in place of a paper ticket to access an event such as a concert or sporting event. The embodiment further recognizes that a relevant advertisement can be injected into the mobile event pass document if the advertisement is properly sized to not interfere with other features of the event pass. Proper sizing requires dynamically resizing the advertisement based on the size of the target display of the mobile device as well as the size of the other features of the event pass.

Among its several aspects, another embodiment of the present invention recognizes the advantage of resizing a mobile document for a specific mobile device prior to sending the mobile document to the mobile device. This removes any requirement for specializes software on the mobile device to resize the mobile document. A standard web browser is all that is needed to display the mobile document because the mobile document has been properly sized to the display of the mobile device before it is delivered.

In accordance with an embodiment of the present invention, there is provided a system for injecting an advertisement into a mobile document. The system includes an airline flight reservation system and a mobile boarding pass system. The invention further includes a method for operating the mobile boarding pass system. To this end, a computer implemented method for injecting an advertisement into a mobile document may suitably comprise: receiving a mobile document request from a mobile device wherein the request includes information uniquely identifying a mobile document and information about the mobile device; receiving a digital advertisement selected to be relevant to the requested mobile document; adjusting the display size of the advertisement based on the size of the display of the mobile device and a predetermined layout for the requested mobile document; generating an optical code using information about the requested mobile document wherein the display size of the generated optical code is based on the size of the display of the mobile device and the predetermined layout for the requested mobile document; and transmitting, in response to the received mobile document request, a mobile document formatted according to the predetermined layout for the requested mobile document to the mobile device wherein the mobile document includes the size adjusted advertisement and the generated optical code.

A more complete understanding of the present invention, as well as further features and advantages of the invention, will be apparent from the following Detailed Description and the accompanying Drawings.

### BRIEF DESCRIPTION OF THE DRAWINGS

The aspects of the claimed invention can be better understood with reference to the Drawings and the Detailed Description. The Drawings are not necessarily drawn to scale. Throughout the Drawings, like element numbers are used to describe the same parts throughout the various drawings, figures and charts.

FIG. 1 is a high-level block diagram illustrating an exemplary embodiment of mobile document advertisement injection system of the present invention including a mobile boarding pass system.

FIG. 2A is a high-level block diagram illustrating selected software components of the mobile boarding pass system of FIG. 1.

FIG. 2B is a high-level block diagram illustrating selected hardware components of a mobile boarding pass computer server.

FIG. 3 is a high-level block diagram illustrating an embodiment of a predetermined mobile document layout.

FIG. 4 is a high-level flow chart illustrating an exemplary method for operating the mobile document advertisement injection system.

FIG. 5 is a high-level block diagram illustrating another embodiment of the mobile document advertisement injection system of the present invention.

### DETAILED DESCRIPTION

In the following description, numerous details are set forth to provide an understanding of the claimed invention. However, it will be understood by those skilled in the art that aspects of the claimed invention may be practiced without utilizing all of these details and that numerous variations or modifications from the described embodiments are possible and envisioned.

As used herein, the term optical code includes machine-readable indicia that includes, but is not limited to, one-dimensional (1D) barcodes and two-dimensional (2D) barcodes. Two-dimensional barcodes include, but are not limited to, Aztec™ barcodes, Data Matrix™ barcodes, PDF417™ barcodes and Quick Response™ (QR) barcodes.

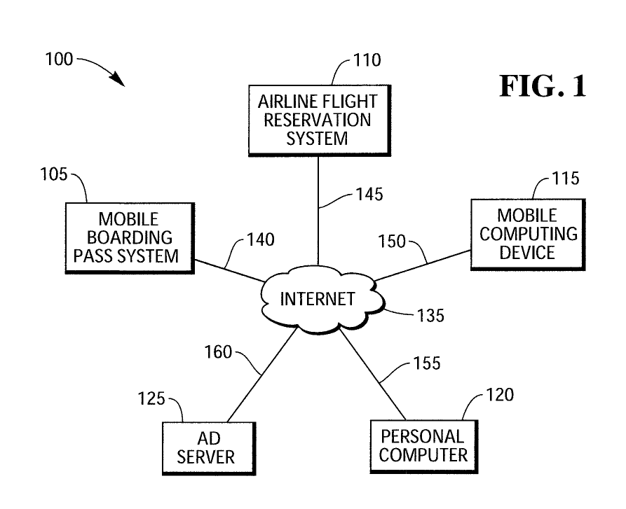

Referring now to FIG. 1, there is provided a high-level block diagram illustrating an exemplary embodiment of mobile document advertisement injection system 100. The system 100 includes a mobile boarding pass system 105, an airline flight reservation system 110, a mobile computing device 115, a personal computer (PC) 120 and an advertisement (ad) server 125. All of these elements are connected to the Internet 135 and use the Internet 135 to communicate. Before connecting to the Internet 135, some of the elements physically connect to other networks, for example, a cellular network, a digital subscriber line (DSL) network, a cable TV broadband network or leased lines.

The airline flight reservation system 110 includes a number of server computers that support web pages, databases and applications that implement the flight reservation system 110 for the airline. The flight reservation system 110 provides a number of services to a customer including providing flight information, making reservations, purchasing a ticket, checking in for a flight and generating a boarding pass for a flight. The airline flight reservation system 110 is connected to the Internet 135 through a high speed network connection 145.

The customer uses the personal computer (PC) 120 connected to the Internet 135 to interact with the airline flight reservation system 110 to purchase a ticket for a flight. In some embodiments, the customer uses the mobile computing device 115 instead of the PC 120 to interact with the airline flight reservation system 110. After purchasing the ticket and usually within 24 hours of the flight, the customer returns to the airline flight reservation system 110 to check in and generate a boarding pass. The boarding pass gives the customer access to restricted sections of the airport terminal and is used to allow the customer to board the flight. More details about the boarding pass are provided below. The PC is connected to the Internet 135 using a data network 155. The data network 155 may include, but is not limited to a digital cable TV network, a DSL network or a cellular network. In some embodiments, the function of making the flight reservation is performed by a computing device other than the PC 120. For example, a tablet computer or smart phone may also be used to make the flight reservation.

The mobile computing device 115 is a small handheld computing device such as a tablet computer or a smart cellular phone and is connected to the Internet 135 over a cellular network 150. In some embodiments, the connection to the Internet 135 is over a wireless local area network (WLAN). An example of a WLAN network is any wireless network that is based on the Institute of Electrical and Electronics Engineers® (IEEE) 802.11 standards. The mobile computing device 115 includes a display to present visual information and communications that allow it to send and receive data. The mobile computing device 115 further has the ability to send and receive data across the Internet 135. The mobile computing device 115 includes a web browser that receives a uniform resource locator (URL) from a user or other application and requests a web page referenced by the URL from the Internet 135 and displays the returned web page received from the Internet 135. The mobile computing device 115 additionally has the ability to communicate using one or more of the following protocols: short message service (SMS), multimedia messaging service (NMS), wireless application protocol (WAP), WAP Push, and simple mail transfer protocol (SMTP).

The ad server 125 is connected to the Internet 135 over a high speed network 160. The ad server 125 receives a request for an advertisement. The request includes information that is used to select the most appropriate advertisement for the context in which the advertisement will be displayed. The ad server 125 may be embodied in a system of computers, databases and application software. The process of receiving an ad request and delivering a targeted advertisement for display typically involves multiple computers and it is not uncommon for the computers to be operated by different companies. Once the ad request is received, an ad selector program processes the request and determines which advertisement to select. The advertisement includes an ad image stored in a standard Internet image format and an ad URL for a web site related to the advertisement. A standard Internet image format is an image format typically supported by popular web browsers. Some example image formats have the following file extensions JPG, GIF and PNG. When the ad image is displayed by a web browser, selecting the ad image will cause the browser to navigate to the ad URL. The ad selector program may execute on a supercomputer and make billions of decisions every day. The ad selector returns a redirect command, such as a hypertext transfer protocol “HTTP” command, that provides a new web address (URL) to the selected advertisement.

The URL of the selected advertisement points to a content delivery network (CDN) that comprises a global network of computer servers that actually house the image files of the selected advertisement. Storing the ad image files in the CDN reduces the load and data bandwidth needed by the ad servers that run the ad selector program. The CDN's global network of computer servers includes web servers that receive and process URLs for selected advertisements. In response to each received and processed URL, the web servers return one or more image files that comprise the selected advertisement identified in the URL.

In some embodiments, the ad selector returns the ad request to the requestor so a house ad can be used. A house ad is an advertisement for the requestor, in this embodiment, an airline, or an advertisement provided by the requestor. The requester maintains a local ad server that is used to store house advertisements. The local ad server is also used when the external ad server 125 is down or cannot be reached.

The mobile boarding pass system 105 is connected to the Internet 135 over a high speed network 140. The mobile boarding pass system 105 is discussed in more detail below.

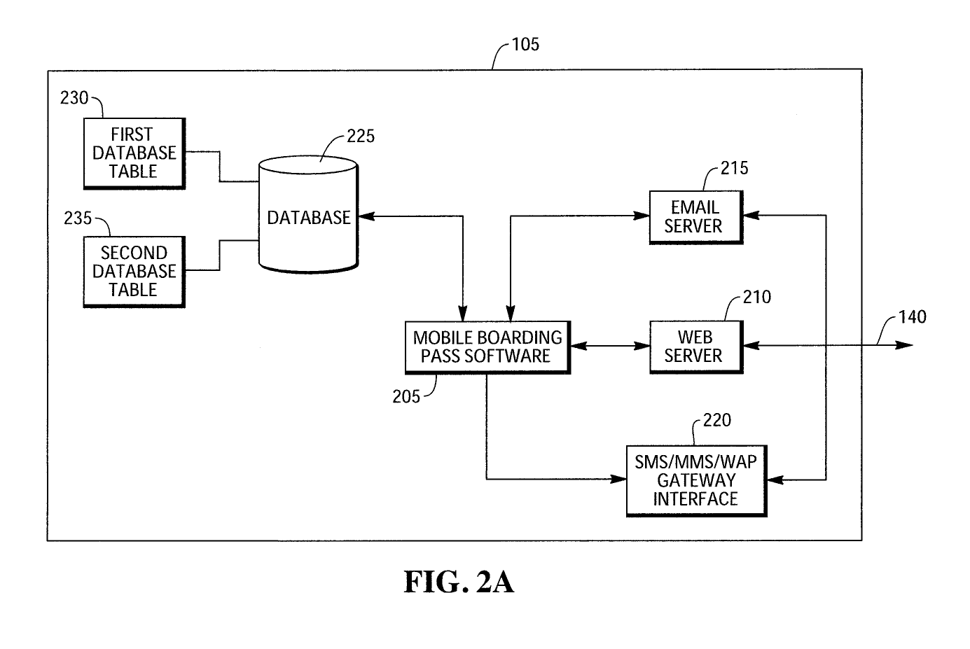

Turning now to FIG. 2A, there is provided a high-level block diagram illustrating selected software components of the mobile boarding pass (MBP) system 105. The MBP system 105 includes the following software components: an email server 215, a web server 210, an SMS/MMS/WAP gateway interface 220, mobile boarding pass application software 205 and a database 225.

The email server 215 sends and receives emails across the Internet 135 using the high speed network 140. The email server 215 supports email protocol standards such as simple mail transfer protocol (SMTP) to send and receive email. The mobile boarding pass software 205 communicates with the email server 215 to process emails that have been received by the email server 215 and to cause the email server 215 to send emails generated by the mobile boarding pass software 205.

The web server 210 services requests for web pages. The web server 210 supports the hypertext transfer protocol (HTTP) to receive requests for web pages and to send data in response to the requests. In this embodiment, the web server 210 is implemented using a software product from Microsoft® called the Internet Information Server® (IIS). In other embodiments, the web server 210 is implemented using the Apache® web server application from Apache Software Foundation®. The mobile boarding pass software 205 is integrated into the web server 210 so that the web server 210 passes external requests for web pages to the mobile boarding pass software 205. The mobile boarding pass software 205 responds to a request for a web page by generating the requested web page and returning it to the web server 210 for delivery to the computer making the request.

The SMS/MMS/WAP gateway interface 220 communicates over the Internet 135 to a number of gateway servers. Each of the gateway servers supports one or more of the three protocols and accepts a message for delivery to a mobile device addressed in the message. The three protocols were developed to send and receive messages between mobile devices on a cellular network. The protocols have been extended so that messages can be sent over the Internet 135 to and from mobile devices. Each wireless carrier has their own gateway server that supports the three protocols on their wireless network and connects to the Internet 135.

The database 225 is implemented using Microsoft's SQL Database Server™ product. Other commercially available database or open source products can also be used. The database 225 includes a first database table 230 and a second database table 235. The first database table 230 is designed and used to store data received from the airline flight reservation system 110 that describes boarding pass documents. Each time a customer requests a mobile boarding pass, the airline flight reservation system 110 sends data to the mobile boarding pass system 105 which stores the data in the first database table 230.

The second database table 235 includes information about all supported mobile computing devices. The information includes basic information about each mobile computing device including the size and resolution of the main display of each device. In this embodiment, a web browser, executing on the mobile computing device 115, issues a request for a web page to the web server 210. HTTP protocol provides for a web browser to include in any web page request information identifying the computer it is executing on or in this case identifying the mobile computing device 115. The web server 210 receives the page request and the device identification information and passes all the information to the mobile boarding pass software 205. The mobile boarding pass software 205 uses the device identification information to lookup information about the mobile computing device 115 stored in the second database table 235.

FIG. 2B is a high-level block diagram illustrating selected hardware components of a mobile boarding pass server computer 200. The software elements of the mobile boarding pass system 105 execute on the mobile boarding pass server computer 200 or on multiple computers similarly configured. The MBP server computer 200 includes at least one processor 250, a memory 255, control circuitry 265 and a network controller 270. The control circuitry 265 allows the processor 250 to communicate with and control the memory 255 and the network controller 270.

The memory 255 uses non-transitory storage devices including both volatile and non-volatile memory. The non-volatile memory may include flash memory, other types of solid state electronic memory and rotating storage devices, such as disk drives or the like. Computer instructions 205 stored in the memory 255 are executed by the processor 250 and causes the processor 250 to control the devices attached to the MBP server computer 200 and to provide the services and functions performed by the software elements of MBP system 105. The data that comprises the database 225 is also stored in the memory 255.

The network controller 270 includes hardware and software required to communicate with the high speed network 140 which ultimately connects to the Internet 135.

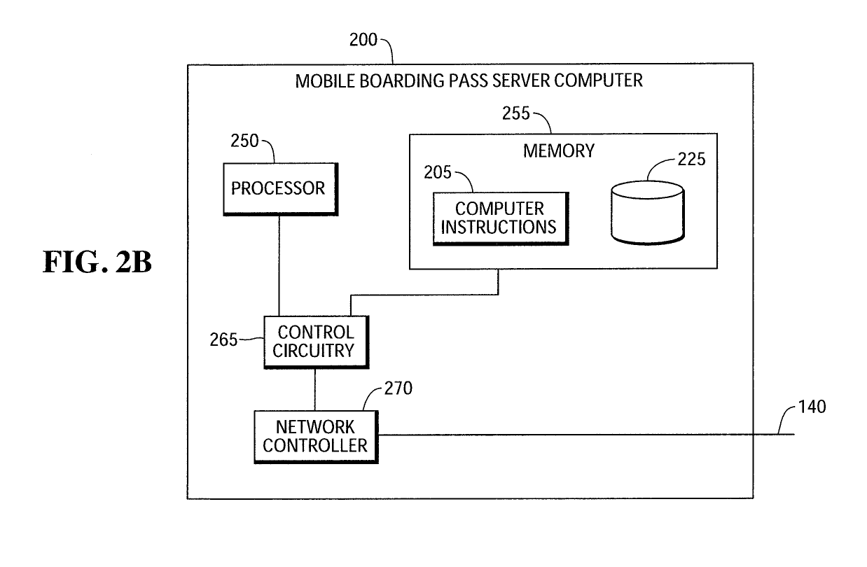

Turning to FIG. 3, there is provided a high-level block diagram illustrating an embodiment of a predetermined mobile document layout 300. The predetermined layout 300 or template is provided by an airline and used to generate their mobile boarding passes. FIG. 3 is a visual depiction of the predetermined layout 300. The actual predetermined layout 300 is a data record that includes information that defines the pixel dimension and document size plus the relative position, function and size of each defined area within the layout.

The relative position information is measured from the top left corner 325 of the predetermined layout 300 which is the origin of the coordinance system. The position of the top left corner of each area is defined along with the height and width of each area. The first area is an airline logo 305. Next is an area for an optical code 310 that is generated as part of the boarding pass. Next is an area for an advertisement image 315. The airline does not provide the advertisement image. The last area is for boarding pass text instructions 320 and used to store instructions from the airline.

In other embodiments, the airline defines additional predetermined layouts 300 that are used for certain groups of passengers, for example, passengers that have obtained different levels within the airline's frequent flyer program. Different airlines will also have different predetermined layouts 300.

In one embodiment, the predetermined layout 300 defines a mobile document that is formatted at a resolution of 960×640 pixels at 326 pixels per inch (PPI) which yields a document that measures 3.5 inches diagonally. This matches the size of an Apple iPhone 4S™ display. If the actual display of the mobile device 115 has a different resolution, the mobile boarding pass software 205 must resize the predetermined layout 300 so that the generated mobile boarding pass document will be properly displayed.

When the mobile boarding pass software 205 determines that a mobile document formatted according to the predetermined layout 300 will not be properly displayed on the targeted mobile device 115, it dynamically modifies the position and size information to match the size of the display of the targeted mobile device 115. The location and height and width of each area are also modified. After the size of each area is modified, the content of each area, for example, an image or text, is either resized to the modified size or created to be the modified size. Images, such as airline logo and advertisement, and text, such as text instructions, are typically resized while an optical code is newly generated for each mobile boarding pass document. The new optical code is generated to be the modified size.

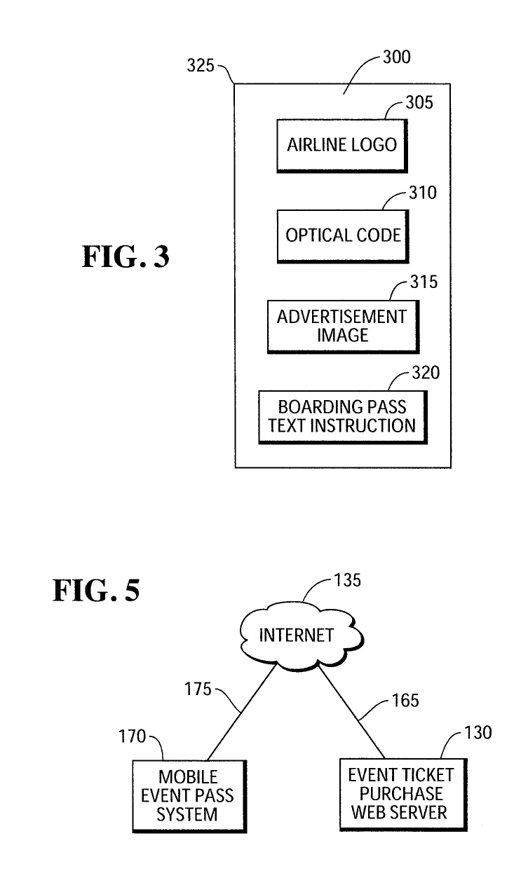

Turning to FIG. 4, there is provided a high-level flow chart illustrating an exemplary method for operating the mobile document advertisement injection system 100. At step 405, the MBP software 205 receives a request to create a mobile document boarding pass for a customer and send it to the customer's mobile device. The request is sent by the airline flight reservation system 110 in response to the customer checking in for a flight and requesting that a boarding pass be sent to a mobile device. The request can include flight number, departure time and date, gate number, terminal information, flight destination, arrival time, customer name, sex, frequent flier status, mobile device address and other related information. The request is sent by email from the airline flight reservation system 110 to the mobile boarding pass system 105. The email is received by the email server 215 and sent to the mobile boarding pass software 205 for processing. In some embodiments, the request is encoded within a URL and web page request is made to the web server 210. The web server 210 receives the request, recovers the encoded information and sends it to the mobile boarding pass software 205 for processing. In still another embodiment, simple object access protocol (SOAP) is used to encode the information and send the request to the web server 210 and to the mobile boarding pass software 205 for processing.

At step 410, the MBP software 205 stores the boarding pass information received in the request to create a mobile document boarding pass in a new record in the first database table 230 of the database 225. A globally unique ID is also created and stored in the record as a unique indexed key that is used to identify and retrieve the record.

At step 415, the MBP software 205 generates a URL encoded with the globally unique ID created to identify the record with the stored boarding pass information. The URL further includes the Internet address of the web server 210. This means that when the URL is used by a web browser on the Internet 135, the request will be serviced by the web server 210 which will send the request to the mobile boarding pass software 205. The mobile boarding pass software 205 will then use the encoded globally unique ID to access the database record in the first database table 230 and retrieve the boarding pass information.

At step 420, the mobile boarding pass software 205 causes the URL to be sent to the mobile device 115. The request to create and send a mobile document boarding pass includes the address for the mobile device 115. The URL is typically stored as text in a WAP PUSH message addressed to the mobile device 115. The WAP message is then sent to the SMS/MMS/WAP Gateway Interface 220 which sends the WAP message to the proper WAP gateway for delivery to mobile device 115. Each of the wireless cellular phone companies have their own gateway computers that receive WAP (and the other protocols) messages and deliver them to mobile devices operating on their cellular network. If WAP messages are not supported for the mobile device 115 or cellular network it is connected to, the mobile boarding pass software 205 will use other protocols such as SMS, MMS or email protocols to deliver the URL to the mobile device 115.

At step 425, the web server 210 receives an external HTTP request for a mobile boarding pass document from the mobile device 115. After the mobile device 115 receives the message with the URL sent in step 420, the user of the mobile device 115 selects the URL which causes a web browser on the mobile device 115 to use the URL to request a web page from the web server 210. The requested web page is the mobile boarding pass document. The web server 210 sends the received request including the URL to the mobile boarding pass software 205 for processing.

At step 430, the mobile boarding pass software 205 recovers the globally unique ID encoded within the URL and uses it to retrieve mobile boarding pass information stored in the first database table 230 of the database 225. This information was stored in step 410 and is information received from the airline describing the flight and the customer.

At step 435, the mobile boarding pass software 205 transmits a request for advertisement to the ad server 125. The request includes the mobile boarding pass information retrieved in step 430. The ad server 125 uses the mobile boarding pass information to identify a relevant advertisement. For example, the ad server 125 may select an advertisement for a rental car company because the company has a sale at the destination airport for the flight. This would be one example of a relevant advertisement for this mobile boarding pass information. The request to the ad server 125 is in the form of a URL encoded with the mobile boarding pass information and is sent using the web server 210.

At step 440, the web server 210 receives an advertisement, as image data, from the ad server 210. The advertisement has been determined by the ad server 210 to be relevant to the flight, the airline or the customer. The received advertisement is sent to the mobile boarding pass software 205.

At step 445, the mobile boarding pass software 205 retrieves information describing the characteristics of the display on the mobile device 115 from the second database table 235 in the database 225. The second database table 235 includes display information for all supported mobile devices. When the web browser on the mobile device 115 sends the request for the mobile boarding pass document, the request includes information identifying the mobile device 115. The identifying information was received in step 425 and is used to retrieve information about the mobile device 115 from the second database table 235. The retrieved information includes the screen size and resolution for the main display on the mobile device 115.

At step 450, the mobile boarding pass software 205 determines if the mobile boarding pass document and the received advertisement must be resized to be properly displayed on the display of the mobile device 115. The mobile boarding pass software 205 uses document size and resolution information in the predetermined layout 300 and the screen size and resolution for the main display of the mobile device 115 to determine if the predetermined layout 300 must be resized. When resizing is required, the mobile boarding pass software 205 modifies the predetermined layout 300 including modifying the position and size of each defined area so a mobile boarding pass document formatted to the modified predetermined layout 300 will be properly displayed on the display of the mobile device 115. If the image for the received advertisement does not match the modified size for the advertisement area 315, the mobile boarding pass software 205 dynamically resizes the image to the modified size.

In step 455, the mobile boarding pass software 205 generates an optical code using information about the requested mobile boarding pass document. The information is the information retrieved from the first database table 230 in step 425. The generated optical code is stored as an image and sized to match the size of the optical code area 310 in the predetermined layout 300 or, if modified, the modified size.

In step 460, the mobile boarding pass document is assembled according to the predetermined layout 300, or the modified predetermined layout if the predetermined layout 300 has been modified. The assembled document includes the dynamically resized advertisement and the generated optical code. The mobile boarding pass software 205 causes the assembled mobile boarding pass document to be transmitted to the mobile device 115 in response to the request received in step 425 from the mobile device 115. The document is transmitted by the web server 210.

In step 465, the mobile boarding pass software 205 transmits an acknowledgement back to the airline flight reservation system 110 confirming that a mobile boarding pass document has been delivered according to the request received in step 405.

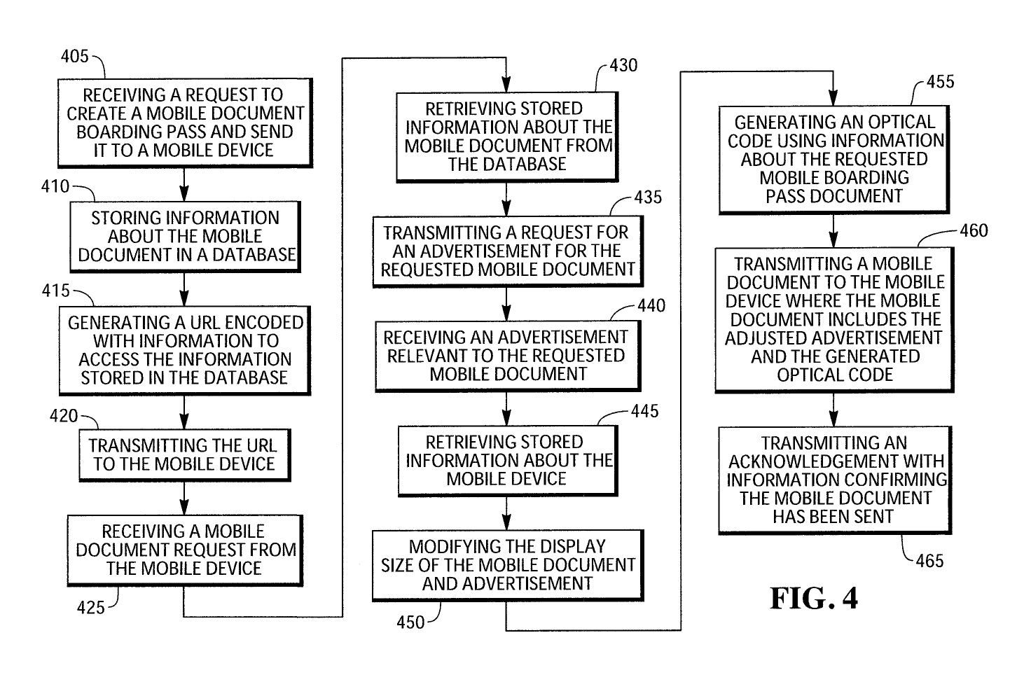

FIG. 5 provides a high-level block diagram illustrating another embodiment of the mobile document advertisement injection system of the present invention. This embodiment is a mobile event pass system 170 which creates and sends a mobile event pass document. In this embodiment, a customer purchases a ticket to an event such as a concert or sporting event using an event ticket purchase web server 130. To gain entrance to the event, the customer requests that a mobile event pass document be sent to a mobile device of the customer. An optical code in the mobile event pass document will, when scanned and processed, identify the customer and event that has been purchased and allow the customer to gain access to the event. Similar to the mobile boarding pass system 105, a request to create and send a mobile event pass document is sent to the mobile event pass system 170 and processed in a similar fashion. A relevant advertisement is also injected into the mobile event pass.

The event ticket purchase web server 130 is connected to the Internet 135 over a high speed network 165. The mobile event pass system 170 is connected to the Internet 135 over a high speed network 175.

Although particular reference has been made to embodiments that include injecting advertisements into a mobile boarding pass system and a mobile event pass system and examples have been provided illustrating the invention, certain other embodiments, variations and modifications are also envisioned within the spirit and scope of the following claims.

We claim:

1. A computer implemented method for injecting an advertisement into a mobile document, the method comprising:
receiving a mobile document request from a mobile device wherein the request includes information uniquely identifying a mobile document and information about the mobile device;
receiving a digital advertisement selected to be relevant to the requested mobile document;
adjusting the display size of the advertisement based on the size of the display of the mobile device and a predetermined layout for the requested mobile document;
generating an optical code using information about the requested mobile document wherein the display size of the generated optical code is based on the size of the display of the mobile device and the predetermined layout for the requested mobile document; and
transmitting, in response to the received mobile document request, a mobile document formatted according to the predetermined layout for the requested mobile document to the mobile device wherein the mobile document includes the size adjusted advertisement and the generated optical code.

2. The method of claim 1, wherein the mobile document includes information identifying a purchase from a company.

3. The method of claim 2, wherein the predetermined layout for the mobile document is provided by the company and includes defined areas for the optical code and advertisement.

4. The method of claim 3, wherein generating the optical code includes encoding information about the purchase.

5. The method of claim 4, wherein the purchase is an airline plane ticket, wherein the mobile document is an electronic airline boarding pass and wherein the information encoded in the optical code includes flight and customer information.

6. The method of claim 4, wherein the purchase is an event ticket, wherein the mobile document is an event entry pass and wherein the information encoded in the optical code includes information identifying the event and customer.

7. The method of claim 1, further including retrieving from a database detailed information about the mobile document using the received information that uniquely identifies the mobile document.

8. The method of claim 7, wherein the retrieved detailed information includes the predetermined layout information for the mobile document.

9. The method of claim 1, wherein the digital advertisement includes a digital image.

10. The method of claim 1, wherein receiving the mobile document request includes receiving a uniform resource locator (URL) requesting to view a web page where the URL is encoded with the information uniquely identifying the mobile document.

11. The method of claim 10, wherein transmitting the mobile document includes sending the mobile document as the response to the request to view a web page.

12. The method of claim 2, further including:
receiving a request from the company to send a mobile document to a mobile device wherein the request includes information about the mobile document and information required to communicate with the mobile device.

13. The method of claim 12, further including:
storing the information about the mobile document and the mobile device received in the request from the company in a database with a unique key value where the unique key value is used to retrieve the stored information received in the request;
generating a uniform resource locator encoded with the unique key value; and
transmitting the uniform resource locator to the mobile device.

14. The method of claim 13, wherein short message service (SMS) protocol is used to transmit the uniform resource locator to the mobile device.

15. The method of claim 13, wherein multimedia messaging service (MMS) protocol is used to transmit the uniform resource locator to the mobile device.

16. The method of claim 13, wherein email message protocol is used to transmit the uniform resource locator to the mobile device.

17. The method of claim 13, wherein the push feature of wireless application protocol (WAP) is used to transmit the uniform resource locator to the mobile device.

18. The method of claim 12, further including transmitting an acknowledgement to the company in response to the request from the company to send a mobile document wherein the acknowledgement includes information confirming the mobile document was transmitted to the mobile device.

19. The method of claim 1, further including transmitting a request for an advertisement relevant to the requested mobile document wherein the request includes information about the mobile document used to select a relevant advertisement.

20. One or more non-transitory digital storage media storing instructions which, when executed by one or more computing devices, cause performance of the method recited in claim 1.

21. A computer apparatus comprising:
a network controller in communication with the Internet where the network controller sends and receives data to computing devices using the Internet;
a memory including software;
a processor in communication with the network controller and the memory, where the processor executes the software which causes the processor to perform functions including:
receiving a mobile document request from a mobile device wherein the request includes information uniquely identifying a mobile document and information about the mobile device;
receiving a digital advertisement selected to be relevant to the requested mobile document;
adjusting the display size of the advertisement based on the size of the display of the mobile device and based on a predetermined layout for the requested mobile document;
generating an optical code using information about the requested mobile document wherein the display size of the generated optical code is based on the size of the display of the mobile device and on the predetermined layout for the requested mobile document; and
transmitting, in response to the received mobile document request, a mobile document formatted according to the predetermined layout for the requested mobile document to the mobile device wherein the mobile document includes the size adjusted advertisement and the generated optical code.
